(19) United States
(12) Patent Application Publication
(10) Pub. No.: US 2006/0137135 A1
(43) Pub. Date: Jun. 29, 2006

(54) DEVICE FOR FIXING INDOOR FLOOR MAT FOR AUTOMOBILE

(76) Inventor: HONG KI JEON, Seoul (KR)

Correspondence Address: IPLA P.A., 3580 WILSHIRE BLVD., 17TH FLOOR, LOS ANGELES, CA, 90010, US

(21) Appl. No.: 10/908,851

(22) Filed: May 27, 2005

(30) Foreign Application Priority Data
Dec. 24, 2004 (KR) 10-2004-0111637

(51) Int. Cl. B60B 37/00

(52) U.S. Cl. 16/40

(57) ABSTRACT

The automobile floor mat fixing device is supported and combined on the carpet on the indoor floor of the automobile, and includes a coupling support on the bottom surface of which at least two wedges which are rotated and inserted into the carpet to then be fixed on the carpet are aligned and combined in a circle, and on the upper surface of which a support protrusion having a stopper protrusion is protrudingly formed at a predetermined height, and an eyelet which is fixedly combined on the mat laid on the carpet and includes a support hole through which the support protrusion of the coupling support is fitted to then be supported on and coupled with the coupling support.

### BACKGROUND OF THE INVENTION

1. Field of the Invention

The present invention relates to a device for fixing an indoor floor mat for an automobile, and more particularly, to an automobile floor mat fixing device for stably fixing an indoor floor mat which is laid on a carpet covering an indoor floor of the automobile in order to protect the carpet from being dirty due to foreign matter such as soil and dust.

2. Description of the Related Art

In general, an automobile indoor floor is covered with a carpet in order to enhance an external appearance and a touch. A mat of a predetermined size is laid on the carpet to thus protect the carpet from being dirty due to foreign matter such as soil, rainwater and dust.

However, since the mat is not fixed on the carpet, the former laid on the latter may move to a certain place by movement of the automobile or the bottom of the shoes of a driver who manipulates pedals during driving. The movement of the mat does not make the carpet from being protected perfectly. In a severe case, a mat laid on the floor of a driver's seat may move to the direction of a brake pedal, a clutch pedal, and an accelerator pedal and obstructs a driver from manipulating the pedals, which may thus induce a safety accident.

### SUMMARY OF THE INVENTION

To solve the above problems, it is an object of the present invention to provide an automobile floor mat fixing device in which a mat can be conveniently and stably fixed to or separated from a carpet covering an automobile indoor floor, to thereby prevent a safety accident due to the mat and a damage to the carpet beforehand.

To accomplish the above object of the present invention, there is provided an automobile floor mat fixing device which is supported and combined on a carpet on the indoor floor of the automobile, the automobile floor mat fixing device comprising: a coupling support on the bottom surface of which at least two wedges which are rotated and inserted into the carpet to then be fixed on the carpet are aligned and combined in a circle, and on the upper surface of which a support protrusion having a stopper protrusion is protrudingly formed at a predetermined height; and an eyelet which is fixedly combined on a mat laid on the carpet and includes a support hole through which the support protrusion of the coupling support is fitted to then be supported on and coupled with the coupling support.

Preferably, each of the wedges formed on the bottom of the coupling support comprises a gimlet portion which is inserted into the carpet, a stopper which is locked in the carpet, a combiner combined with the bottom of the coupling support, and locking hooks which are formed on the gimlet portion and the stopper to thereby prevent the wedge from being seceded from the carpet, in which the gimlet portion, the stopper and the combiner are bent in a multistage and consecutively formed on a single body.

Preferably, a grip which allows a user to grasp it by the hand and to easily turn it is formed on the outer circumferential portion of the coupling support.

Preferably, a screw hole is formed to be opened upwards in the support protrusion of the coupling support, and a locking bolt having a locking head portion on its one end is engaged with the screw hole of the coupling support, to support and fix the mat fitted into the coupling support.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a perspective view showing an automobile floor mat fixing device according to the present invention;

FIG. 2 is a perspective view showing a coupling support which is an essential component of the automobile floor mat fixing device according to the present invention, viewed from another direction;

FIGS. 3A and 3B are a cross-sectional view showing a shape that the automobile floor mat fixing device according to the present invention is applied on a mat, respectively;

FIG. 4A is a perspective view showing an automobile floor mat fixing device according to another embodiment of the present invention; and

FIG. 4B is a cross-sectional view showing the automobile floor mat fixing device of FIG. 4A.

### DETAILED DESCRIPTION OF THE INVENTION

An automobile floor mat fixing device according to a preferred embodiment of the present invention will be described with reference to the accompanying drawings.

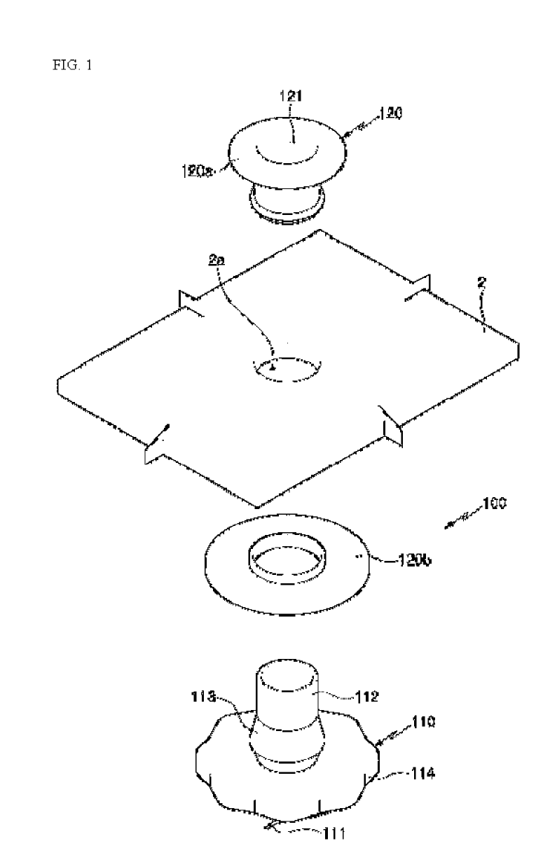

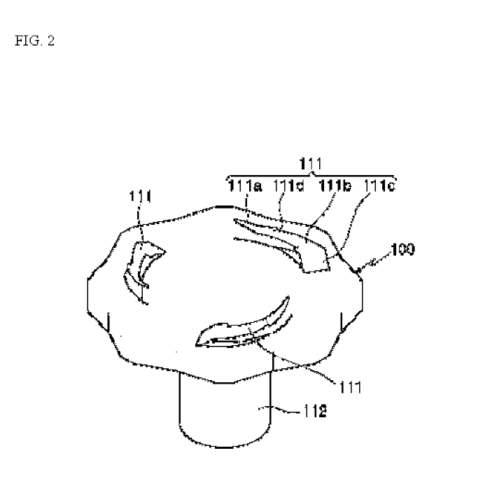

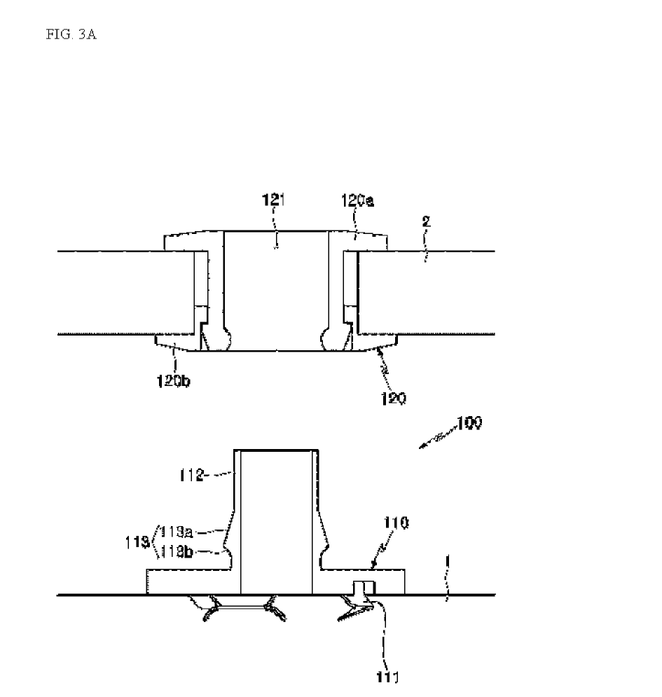

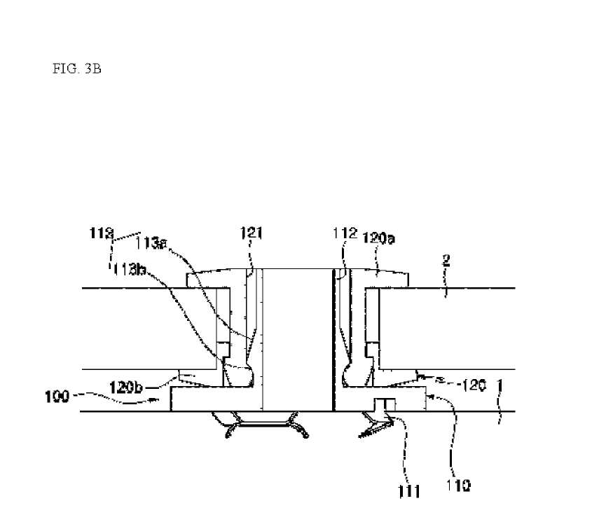

As shown in FIGS. 1 through 3B, an automobile floor mat fixing device 100 according to a preferred embodiment of the present invention, is supported and combined on a carpet 1 laid on the indoor floor of the automobile, and includes a coupling support 110 on the bottom surface of which at least two wedges 111 which are rotated and inserted into the carpet 1 to then be fixed on the carpet 1 are aligned and combined in a circle, and on the upper surface of which a support protrusion 112 having a stopper protrusion 113 is protrudingly formed at a predetermined height; and an eyelet 120 which is fixedly combined on a mat 2 laid on the carpet 1 and includes a support hole 121 through which the support protrusion 112 of the coupling support 110 is fitted to then be supported on and coupled with the coupling support 110.

Each wedge 111 formed on the bottom of the coupling support 110 includes a gimlet portion 111a which is inserted into the carpet 1, a stopper 111b which is locked in the carpet 1, a combiner 111c combined with the bottom of the coupling support 110, and locking hooks 111d which are formed on the gimlet portion 111a and the stopper 111b to thereby prevent the wedge 111 from being seceded from the carpet 1, in which the gimlet portion 111a, the stopper 111b and the combiner 111c are bent in a multistage and consecutively formed on a single body.

On the stopper protrusion 112 formed in the support protrusion 112 of the coupling support 110 are formed an insertion slant portion 113a with which the support hole 121 of the eyelet 120 passing the stopper protrusion 113 is locked and a locking stopper 113b which prevents the eyelet 120 having passed the stopper protrusion 113 from being easily separated.

On the outer circumferential portion of the coupling support 110 is formed a grip 114 which allows a user to grasp it by the hand and to easily turn it.

The eyelet 120 is fitted into and fixedly coupled with a coupling hole 2a perforated and formed on the mat 2, and includes an eyelet bushing 120a which is fitted into and fixedly coupled with the coupling hole 2a of the mat 2 and an eyelet washer 120b which is integrally combined with the eyelet bushing 120a having passed the coupling hole 2a of the mat 2.

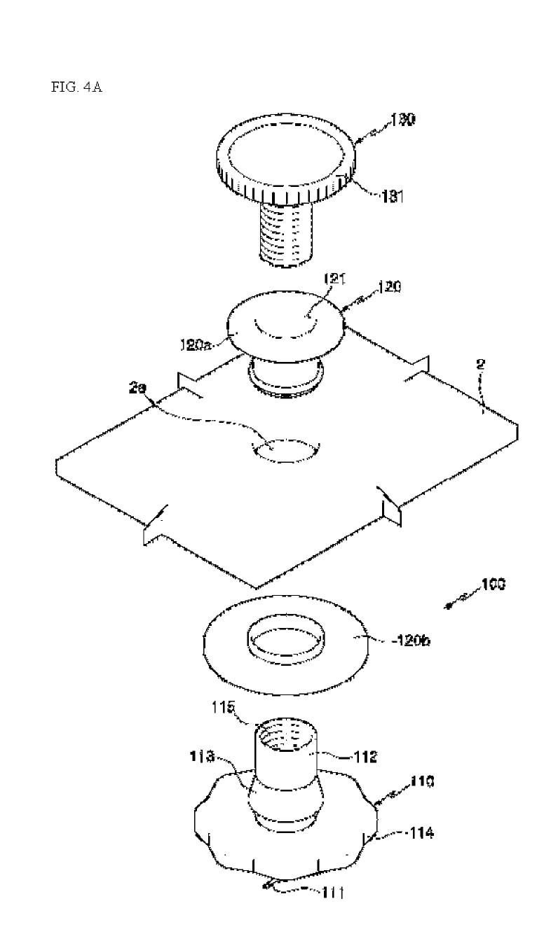

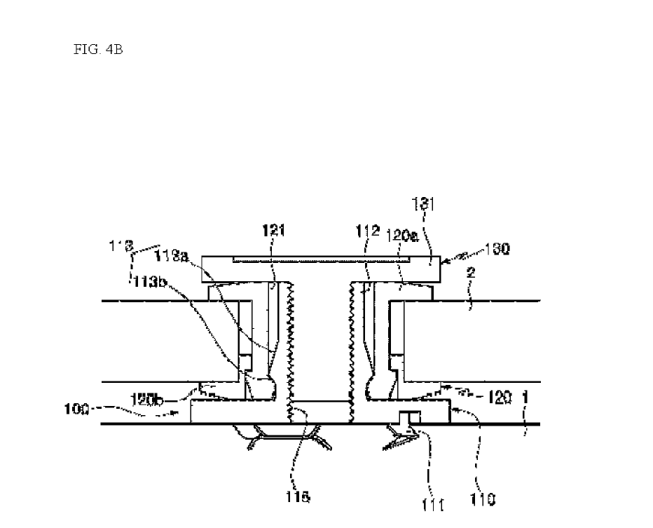

FIG. 4A is a perspective view showing an automobile floor mat fixing device according to another embodiment of the present invention, and FIG. 4B is a cross-sectional view showing the automobile floor mat fixing device of FIG. 4A.

Meanwhile, as being the case, as shown in FIGS. 4A and 4B, a screw hole 115 is formed to be opened upwards in the support protrusion 112 of the coupling support 110. A locking bolt 130 having a locking head portion 131 on its one end is engaged with the screw hole 115 of the coupling support 110, to support and fix the mat 2 fitted into the coupling support 110.

The function of the automobile floor mat fixing device according to the present invention will follow.

When a mat 2 is fixed on a carpet 1 laid on an indoor floor of an automobile using an automobile floor mat fixing device according to the present invention, a coupling hole 2a is formed on the mat 2 in the first place.

Then, an eyelet bushing 120a of an eyelet 120 is fitted and inserted into the coupling hole 2a. Then, an eyelet washer 120b is combined on one end of the eyelet bushing 120a, to thus integrally fixedly coupling the eyelet 120 on the mat 2.

Thereafter, wedges 111 on the coupling support 110 are loaded on a carpet 1 laid on an indoor floor of an automobile, and then are pressed and turned so that the wedges 111 of the coupling support 110 are inserted into and combined with the carpet 1. Accordingly, the coupling support 110 is supported on and fixed on the carpet 1.

Thereafter, a support hole 121 of the eyelet 120 which is integrally combined on the mat 2 is inserted into the support protrusion 112 of the coupling support 110 which is supported and fixed to the carpet 1, and then is pressed to make the eyelet 120 pass the stopper protrusion 113 of the support protrusion 112 and locked and supported with the stopper protrusion 113. Accordingly, the mat 2 laid on the carpet 1 is completely fixed on the carpet 1, to thus complete a fixing work for the mat to be fixed on the carpet.

Meanwhile, a locking bolt 130 is engaged with a screw hole 115 formed on the support protrusion 112 of the coupling support 110 with which the eyelet 120 combined on the mat 2 is fitted. Accordingly, the mat 2 fitted into the coupling support 110 can be supported and fixed on the carpet 1 more firmly.

As described above, the automobile floor mat fixing device according to the present invention can easily and conveniently fix the mat on the carpet laid on the indoor floor of the automobile. Also, the coupling support connecting the mat and the carpet is not exposed externally. As needed, the mat can be easily separated from the carpet and the coupling support, to thereby enhance convenience and safety in use of the mat.

As described above, the present invention has been described with respect to a particularly preferred embodiment. However, the present invention is not limited to the above embodiments, and it is possible for one who has an ordinary skill in the art to make various modifications and variations, without departing off the spirit of the present invention.

What is claimed is:

1. An automobile floor mat fixing device which is supported and combined on a carpet on the indoor floor of the automobile, the automobile floor mat fixing device comprising:
a coupling support on the bottom surface of which at least two wedges which are rotated and inserted into the carpet to then be fixed on the carpet are aligned and combined in a circle, and on the upper surface of which a support protrusion having a stopper protrusion is protrudingly formed at a predetermined height; and
an eyelet which is fixedly combined on a mat laid on the carpet and includes a support hole through which the support protrusion of the coupling support is fitted to then be supported on and coupled with the coupling support.

2. The automobile floor mat fixing device according to claim 1, wherein each of the wedges formed on the bottom of the coupling support comprises a gimlet portion which is inserted into the carpet, a stopper which is locked in the carpet, a combiner combined with the bottom of the coupling support, and locking hooks which are formed on the gimlet portion and the stopper to thereby prevent the wedge from being seceded from the carpet, in which the gimlet portion, the stopper and the combiner are bent in a multistage and consecutively formed on a single body.

3. The automobile floor mat fixing device according to claim 1, wherein a grip which allows a user to grasp it by the hand and to easily turn it is formed on the outer circumferential portion of the coupling support.

4. The automobile floor mat fixing device according to claim 1, wherein a screw hole is formed to be opened upwards in the support protrusion of the coupling support, and a locking bolt having a locking head portion on its one end is engaged with the screw hole of the coupling support, to support and fix the mat fitted into the coupling support.
